(19) United States
(12) Patent Application Publication
(10) Pub. No.: US 2014/0317906 A1
(43) Pub. Date: Oct. 30, 2014

(54) MASK FOR LIQUID CRYSTAL DISPLAY PANEL AND METHOD USING THE SAME

(71) Applicant: SHENZHEN CHINA STAR OPTOELECTRONICS TECHNOLOGY CO. LTD., Shenzhen (CN)

(72) Inventors: Shih-Hsun Lo, Shenzhen (CN); Bing Han, Shenzhen (CN); Zhensai Tang, Shenzhen (CN)

(21) Appl. No.: 14/126,442

(22) PCT Filed: Jun. 27, 2013
(86) PCT No.: PCT/CN2013/078233

§ 371 Date: Dec. 16, 2013

(30) Foreign Application Priority Data
Apr. 12, 2013 (CN) 201310126219.1

(51) Int. Cl. G02F 1/1339; G02B 5/20

(52) U.S. Cl. CPC G02F 1/1339; G02B 5/208
USPC 29/527.2; 359/361

(57) ABSTRACT

A mask utilized in a liquid crystal display (LCD) panel is disclosed in the present invention, and the mask comprises a substrate; a light shielding layer disposed on the substrate and separated into a first light shielding region and a second light shielding region and the first light shielding region is for shielding the UV light and the second light shielding region is for shielding the UV light and absorbing the UV light reflected from the TFT substrate of the LCD panel; and a photic region disposed on the substrate and adjacent to an area of the light shielding layer and allowing the UV light to pass therethrough.

### FIELD OF THE INVENTION

The present invention relates to a field of a mask of a thin film transistor (TFT) liquid crystal display (LCD) panel, and more particularly relates to a mask of a TFT LCD panel to prevent an illumination of an Ultra-Violet (UV) light.

### BACKGROUND OF THE INVENTION

According to the technology improvement of the LCD panel, different vendors develop different types of the LCD panels, such as Twisted Nematic (TN), Vertical Alignment (VA), In-Plane Switching (IPS), Polymer Stabilized Vertical Alignment (PSVA) and so on. During the manufacturing procedures of the PSVA LCD panel, the liquid molecules within the liquid crystal layer are mixed with monomers. When the monomers within the liquid crystal layer are illuminated by the UV light, the illuminated monomers will be polymerized. In the following alignment processes of the liquid crystal layer, the property of the polymerized monomers is different to other monomers. When the illuminated monomers are aligned by the same voltage and light, different pretilt angles are formed within the liquid crystal layer. Especially, the pretilt angles formed by the illuminated monomers at edges of the liquid crystal layer are more disorder than any other places, and the display performance of the PSVA LCD device is affected.

FIG. 1 is a view illustrating a mask of a conventional LCD panel. As shown in FIG. 1, the mask 10 includes a transparent substrate 102, a light shielding region 104 formed on the transparent substrate 102 and made by a light shielding material and a photic region 106, which is not covered by the light shielding material. The photic region 106 is corresponding to a non-display region of the LCD panel and the light shielding region 104 is corresponding to a display region of the LCD panel. Therefore, the UV light can only illuminate an area corresponding to the non-display region on the liquid crystal layer and a sealant is illuminated and solidified by the UV light to seal liquid crystal molecules within the liquid crystal layer of the LCD panel.

FIG. 2 is a view illustrating a conventional PSVA LCD panel is illuminated with a mask during a manufacturing process. As shown in FIG. 2, after a Thin Film Transistor (TFT) 202 is disposed on a color filter (CF) substrate 204, the TFT substrate 202 with the CF substrate 204 is required to be illuminated by the UV light to solidify the sealant 206, so the TFT 202 and the CF substrate 204 are adhered together. When illumination by the UV light, a mask 208 is used to protect an AA region from the illumination and the AA region is located within the display region of the LCD panel.

However, during the practical operating process, the mask 208, which is for shielding the UV light, is made by sputtering and etching a metal. A light blocking property of the metal is good, but the metal under the sealant 206 can reflect the UV light. There is a certain distance between the mask 208 and the LCD substrate, and partial UV light will be reflected to the mask 208 and the UV light will be reflected again from the mask 208. Therefore, the liquid crystal in the AA region 2022 will be illuminated. Because the liquid crystal molecules 210 are mixed with monomers within the liquid crystal layer of the PSVA LCD, once the monomers within the liquid crystal layer is illuminated by the UV light, a polymerization in the illuminated monomers will be occurred early and light unevenness or irregularity (also called MURA) will be happened in the later period.

Therefore, a need is arisen to develop a novel UV light mask structure to prevent the UV light from illuminating on the monomers within the liquid crystal layer, which will cause the polymerization happen.

### SUMMARY OF THE INVENTION

An object of the present invention is to provide a mask for the TFT LCD panel and the mask can shield the UV light and absorb the UV light reflected from the TFT substrate of the LCD panel.

For achieving the above-mentioned technical solution, the present invention proposes an LCD panel and the LCD panel comprises a mask utilized in a liquid crystal display (LCD) panel, and the mask comprising a substrate; a light shielding layer disposed on the substrate and the light-shielding layer is used for shielding Ultra-Violet (UV) light and absorbing the UV light reflected from a TFT substrate of the LCD panel; and a photic region disposed on the substrate and adjacent to an area of the light shielding layer for allowing the UV light to pass therethrough.

In one embodiment of the present invention, the light shielding layer is made by black resin or black ink, and the substrate is a transparent substrate.

In one embodiment of the present invention, the light shielding layer is separated into a first light shielding region and a second light shielding region and the first light shielding region is for shielding the UV light and the second light shielding region is for shielding the UV light and absorbing the UV light reflected from the TFT substrate of the LCD panel.

Another object of the present invention is to provide a mask for the TFT LCD panel and the mask can prevent the UV light from being illuminated on the display region of the LCD panel and the monomers early polymerized can be avoided,

For achieving the above-mentioned technical solution, the present invention proposes a mask utilized in a liquid crystal display (LCD) panel, and the mask comprising a substrate; a light shielding layer disposed on the substrate and separated into a first light shielding region and a second light shielding region and the first light shielding region is for shielding the UV light and the second light shielding region is for shielding the UV light and absorbing the UV light reflected from the TFT substrate of the LCD panel; and a photic region disposed on the substrate and adjacent to an area of the light shielding layer for allowing the UV light to pass therethrough.

In one embodiment of the present invention, the first light shielding region is made by metal material and the second light shielding region is made by black resin or black ink.

In one embodiment of the present invention, the second light shielding layer overlaps with the first light shielding layer.

In one embodiment of the present invention, the LCD panel is a Polymer Stabilized Vertical Alignment (PSVA) TFT LCD panel.

The other object of the present invention is to provide a method for a mask to be utilized in an LCD. According to the method for using the mask, a sealant between the TFT substrate and the CF substrate can be solidified and the UV light illuminated to the monomers within the liquid crystal layer can be avoided.

For achieving the above-mentioned technical solution, the present invention proposes a method for a mask to be utilized in an LCD panel, and the mask is utilized to solidify a sealant of the LCD panel, the method which is for the mask to be utilized comprises steps of: preparing a mask for shielding a display region of the LCD panel; coating a black material on a surrounding area of a first light shielding region to form a second light shielding region, and the first light shielding region is formed on a light shielding layer of the mask; illuminating UV light on top of the mask and the LCD panel to solidify a sealant between a TFT substrate and a CF substrate; and absorbing the UV light by an absorbing property of the second light shielding region to prevent that the UV light reflected from the non-display region of the LCD panel is reflected again from the second light shielding region to a display region of the LCD panel.

In one embodiment of the present invention, a material of the second light shielding region is black resin or black ink.

In one embodiment of the present invention, the method is used to solidify a sealant in a PSVA LCD panel.

In one embodiment of the present invention, the method is used to prevent monomers within a liquid crystal layer of the LCD panel from being illuminated by the UV light.

The above-mentioned description of the present invention can be best understood by referring to the following detailed description of the preferred embodiments and the accompanying drawings.

### DESCRIPTION OF THE DRAWINGS

FIG. 1 is a view illustrating a mask of a conventional LCD panel;

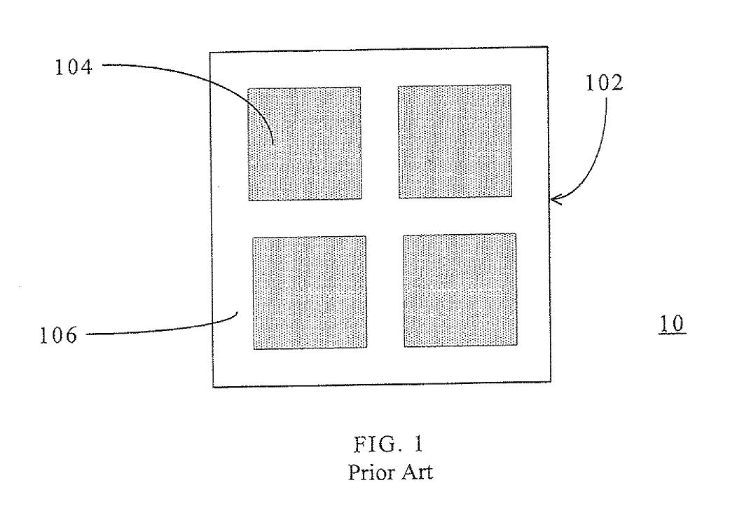

FIG. 2 is a view illustrating a conventional PSVA LCD panel is illuminated with a mask during a manufacturing process;

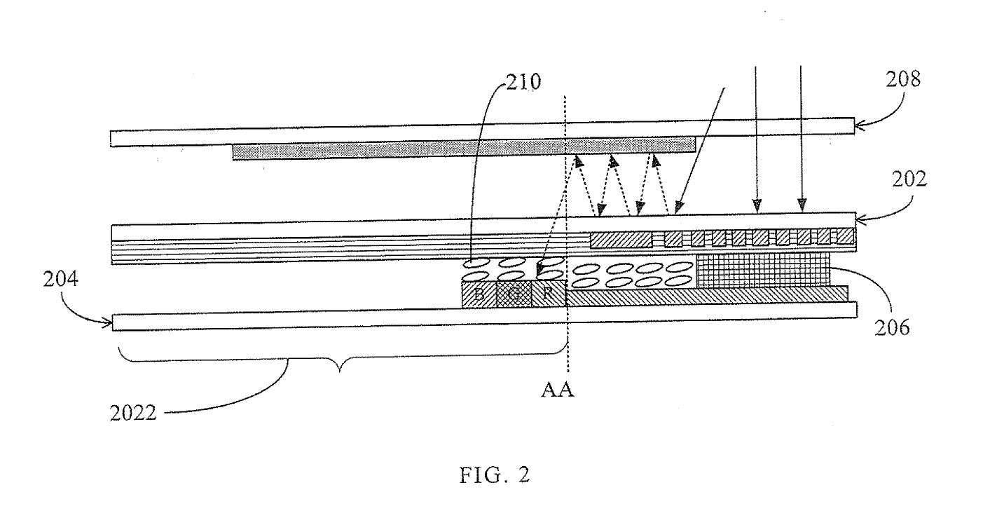

FIG. 3 is a structural view illustrating a mask for solidifying a sealant in a preferred embodiment of the present invention;

FIG. 4A is a view illustrating a sealant solidification of the TFT LCD panel by using a mask in an embodiment of the present invention;

FIG. 4B is a view illustrating the sealant solidification of the TFT LCD panel by using a mask in another embodiment of the present invention; and

FIG. 5 is a flowchart illustrating the steps of solidifying the sealant of the TFT LCD panel by using the mask in the embodiment of the present invention.

### DETAILED DESCRIPTION OF THE PREFERRED EMBODIMENTS

In the following detailed description of the preferred embodiments, reference is made to the accompanying drawings which form a part hereof, and as shown by way of illustration specific embodiments in which the invention may be practiced. As such, the directional terminology is used for purposes of illustration and is in no way limiting the present invention.

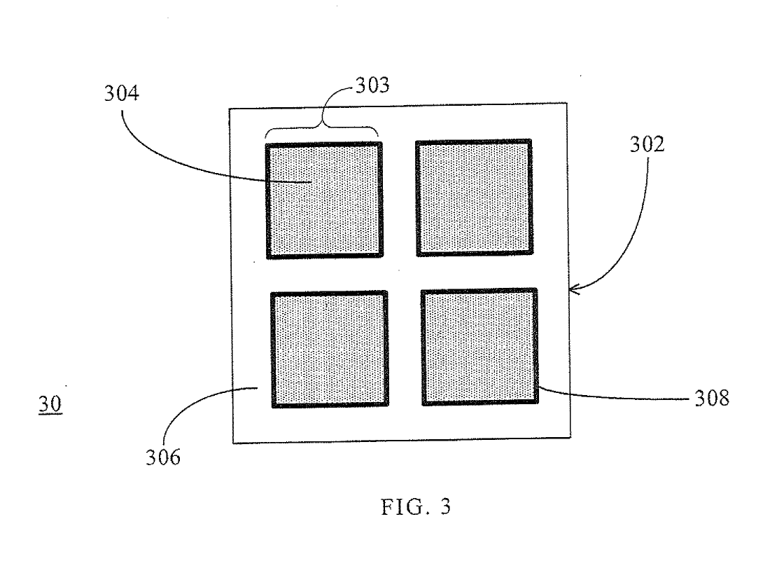

FIG. 3 is a structural view illustrating a mask utilized to solidify a sealant in a preferred embodiment of the present invention. As shown in FIG. 3, the mask 30 is made by a substrate 302. The substrate 302 in the present embodiment is preferred to be a transparent substrate 302, and a light shielding layer 303 and a photic region 306 are formed on the transparent substrate 302. The light shielding layer 303 is separated into a first light shielding region 304 and a second light shielding region 308. The first light shielding region 304 is made by sputtering and etching a metal and the photic region 306 is in an area without metal sputtering. The first light shielding region 304 can shield the UV light from being illuminated during the mask processing step and the UV light is allowed to illuminate in the photic region 306 and pass through the transparent region 302 to solidify the sealant region corresponding to the LCD panel. Moreover, in the embodiment of the present invention, the second light shielding region 308 is disposed between the first light shielding region 308 and the photic region 306 and surrounds the first light shielding region 304. In the embodiment of the present invention, the second light shielding region 308 overlaps with the first light shielding region 304, but in a different embodiment of the present invention, the second light shielding region 308 and the first light shielding region 304 are partially overlapped or the second light shielding region 308 is adjacent to the first light shielding region 304, and it is not limited herein. The second light shielding region 308 is made by a black material and the composition of the black material is resin or ink. Alternatively, any materials which can use to shield the surrounding area of the first light shielding region 308 can be the black material in the present invention. In addition, the color of the second light shielding region 308 is preferred to be black, because the light absorbing performance of the black color is better. The second light shielding region 308 not only can shield the UV light but also prevent that the UV light reflected to the second light shielding region 308 is transmitted on the LCD panel. However, in a different embodiment, the material of the second light shielding region 308 can be any other colors. As long as the purpose of the light absorbing is achieved and the UV light can be stopped to transmit to the LCD panel, any color can be the color of the material of the second light shielding region 308 and it is not limited herein.

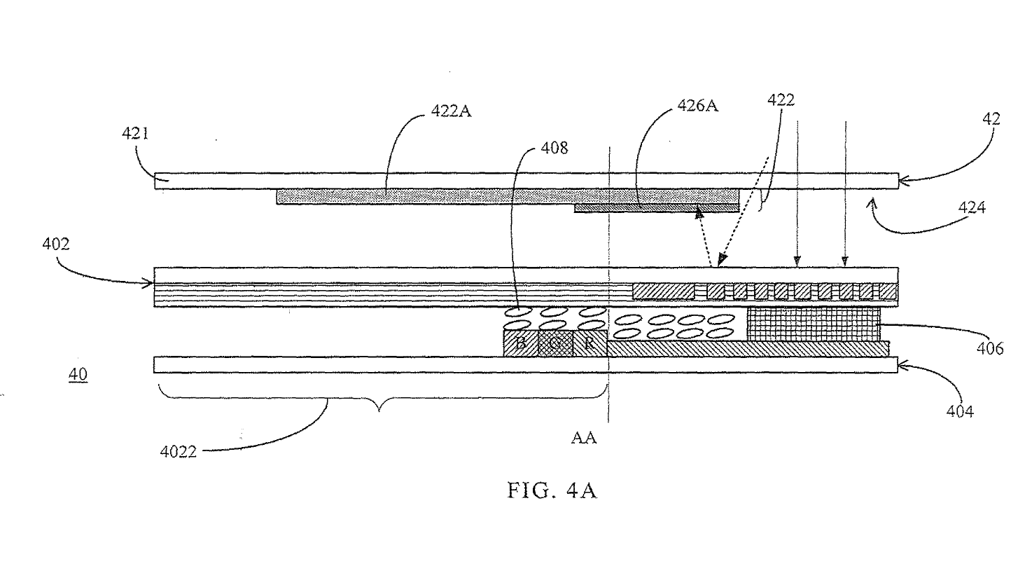

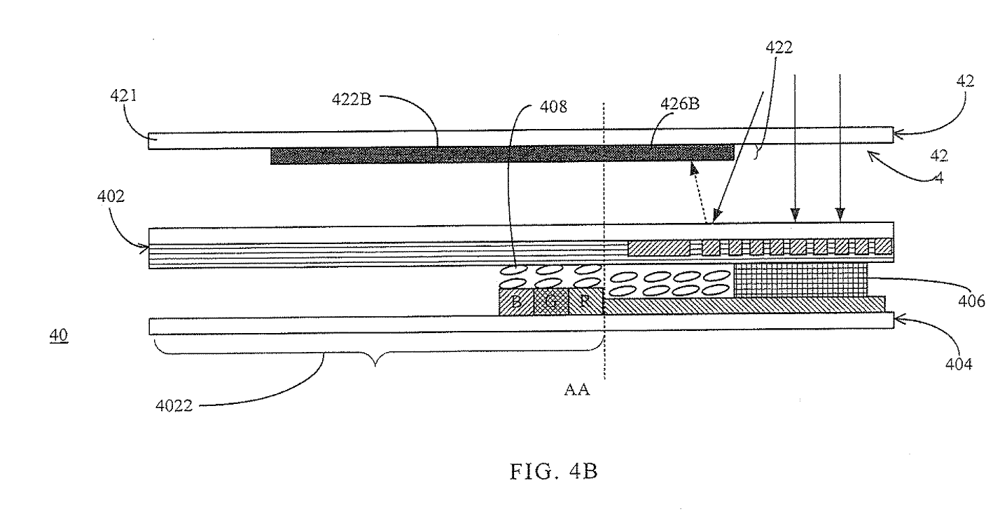

FIG. 4A is a view illustrating a sealant solidification of the TFT LCD panel by using a mask in an embodiment of the present invention. As shown in FIG. 4A, the TFT LCD panel 40 is preferred to be a Polymer Stabilized Vertical Alignment (PSVA) TFT LCD panel. The TFT LCD panel includes a TFT substrate 402, a color filter (CF) substrate 404 and a sealant 406. The mask 42 includes a transparent substrate 421, a light shielding layer 422 and a photic region 424 and the light shielding layer 422 can be separated into a first light shielding region 422A and a second light shielding region 426A. The second light shielding region 426A of the mask 42 is disposed between the first light shielding region 422A and the transparent region 424 and surrounds the first light shielding region 422A. In the present embodiment, the first light shielding region 422A is made by sputtering and etching a metal on the transparent substrate 421. The second light shielding region 426A is made by coating a black material, such as resin or ink, on the first light shielding region 422A and the first light shielding region 422A and the second light shielding region 426A are overlapped. Before the LCD panel 40 is illuminated by the UV light, the mask 42 is disposed on the top of the corresponding LCD panel 40 first. The UV light can illuminate from the photic region 424 of the mask 42 to an area of the sealant 406, which is disposed under the TFC panel 40. Therefore, the sealant 406 is illuminated and solidified by the UV light and the liquid crystal molecules 408 are sealed within the liquid crystal layer of the LCD panel 40. It is clear to see in FIG. 4 that when the UV light is illuminating on the top of the mask 42 and the LCD panel 40, the photic region 424 of the mask 42 can allow the UV light to pass through the LCD panel 40 to solidify the sealant 406. When the UV light passes through the transparent region 424 of the mask 42 to the top of the mask 42, the UV light is reflected from the LCD panel and a portion of the reflected UV light will transmits to the edge of the first light shielding region 422A. The edge of the first light shielding region 422A is the location of the second light shielding region 426A, and the UV light transmitting to the second light shielding region 426A will not be reflected again because of a better light absorbing performance of the second light shielding region 426A. The UV light is reflected again to an AA region 4022 of the LCD panel 30 can be avoided. Because the liquid crystal molecules 408 within the liquid crystal layer in the AA region 4022 is mixed with monomers, the monomers within the liquid crystal layer is illuminated by the UV light and the illuminated monomers will be polymerized early. Because the second light shielding region 426A is installed in the embodiment of the present invention, the monomers within the liquid crystal layer on the AA region 4022 polymerized early can be avoided and the probability of the generation of the MURA problem in the LCD panel can be reduced. The AA region 4022 in FIG. 4A is located within the display region of the LCD panel.

FIG. 4B is a view illustrating the sealant solidification of the TFT LCD panel by using a mask in another embodiment of the present invention. As shown in FIG. 4B, in the present embodiment, the LCD panel also includes a TFT substrate 402, a CF substrate 404 and a sealant 406. The sealant 406 is illuminated to be solidified by the UV light and the liquid crystal molecules 408 are sealed within the crystal layer of the LCD panel 40. In the present embodiment, the light shielding layer 422 is made by coating a black resin on the glass substrate and the area outside of the light shielding layer 422 is the photic layer 424. The light shielding layer 422 is disposed on the substrate 421 and configured for shielding the UV light and absorbing the UV light reflected from the TFT substrate 402 of the LCD panel 40. Furthermore, the light shielding layer 422 is separated into the first light shielding region 422B and the second light shielding region 4263. In the present embodiment, when the UV light illuminates on the TFT substrate 402, the UV light will be reflected and the UV light adjacent to the second light shielding region 426B is reflected to the second light shielding region 426B of the mask 42. Because the second light shielding region 426B is made by the black material, the UV light reflected to the second light shielding region 426B will be absorbed by the second light shielding region 426B due to the better absorbing performance of the second light shielding region 426B. Therefore, the UV light will not be reflected to the AA region 4022 of the TFT substrate 402.

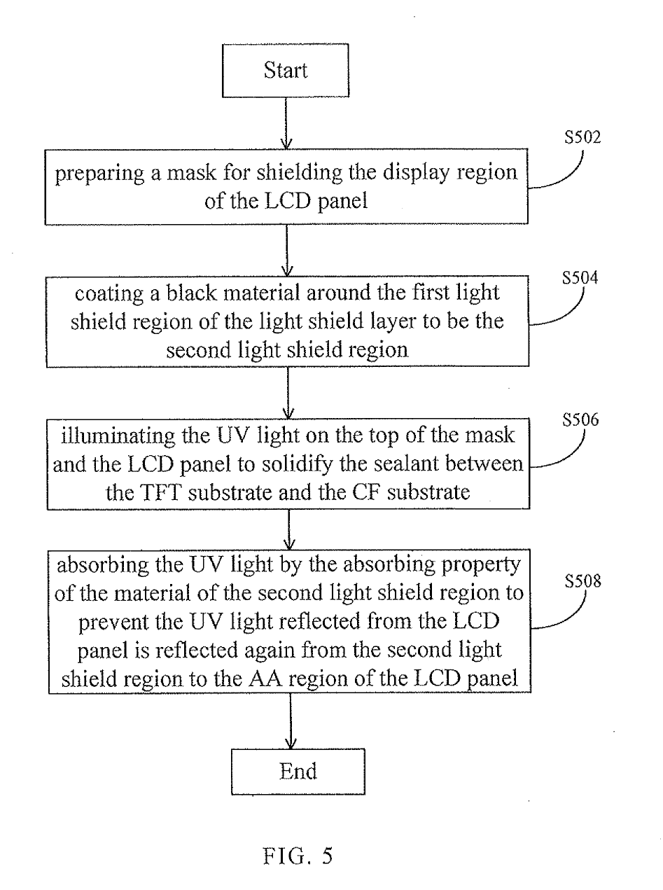

FIG. 5 is a flowchart illustrating the steps for solidifying the sealant of the TFT LCD panel by using the mask in the embodiment of the present invention. The implementing steps in FIG. 5 are interpreted in accordance with the elements cited in the FIG. 4. As shown in FIG. 5, in step S502, it is to prepare a mask 42 for shielding the display region of the LCD panel 40. In step S504, it is to coat the black material around the first light shielding region 422A of the light shielding layer 422 to be the second light shielding region 426A and the material of the second light shielding region 426B is preferred to be resin or ink. In addition, because the black color includes a better light absorbing performance, the color of the material of the second light shielding region 426B is preferred to be black. Thereafter, in step S506, it is to illuminate the UV light on the top of the mask 42 and the LCD panel 40 to solidify the sealant 406 between the TFT substrate 402 and the CF substrate 404. In step S508, it is to absorb the UV light by the absorbing property of the material of the second light shielding region 426A to prevent that the UV light reflected from the LCD panel 40 is reflected again from the second light shielding region 426A to the AA region 4022 of the LCD panel 40. Therefore, according to the steps described above, the UV light transmitted to the AA region 4022 of the LCD panel 40 can be avoided. The monomers within the liquid crystal layer of the PSVA TFT LCD panel will not be illuminated and some of the monomers won't be early polymerized.

As described above, the present invention has been described with preferred embodiments thereof and it is understood that many changes and modifications to the described embodiments can be carried out without departing from the scope and the spirit of the invention that is intended to be limited only by the appended claims.

What is claimed is:

1. A mask for a liquid crystal display (LCD) panel, comprising:
a substrate;
a light shielding layer disposed on the substrate for shielding Ultra-Violet (UV) light and absorbing the UV light reflected from a thin-film transistor (TFT) substrate of the LCD panel; and
a photic region disposed on the substrate and adjacent to an area of the light shielding layer for allowing the UV light to pass therethrough.

2. The mask according to claim 1, wherein the light shielding layer is made by black resin or black ink, and the substrate is a transparent substrate.

3. The mask according to claim 1, wherein the light shielding layer is separated into a first light shielding region and a second light shielding region, and the first light shielding region is for shielding the UV light, the second light shielding region is for shielding the UV light as well as absorbing the UV light reflected from the TFT substrate of the LCD panel.

4. A mask for a liquid crystal display (LCD) panel, comprising:
a substrate;
a light shielding layer disposed on the substrate, and separated into a first light shielding region and a second light shielding region, the first light shielding region is for shielding the UV light, and the second light shielding region is for shielding the UV light and absorbing the UV light reflected from the TFT substrate of the LCD panel; and
a photic region disposed on the substrate and adjacent to an area of the light shielding layer for allowing the UV light to pass therethrough.

5. The mask according to claim 4, wherein the first light shielding region is made by metal material, and the second light shielding region is made by black resin or black ink.

6. The mask according to claim 5, wherein the second light shielding layer is overlapping with the first light shielding layer.

7. The mask according to claim 4, wherein the LCD panel is a Polymer Stabilized Vertical Alignment (PSVA) TFT LCD panel.

8. A method for a mask utilized in an LCD panel, the mask for solidifying a sealant of the LCD panel, characterized in that, the method comprises steps of:
preparing a mask for shielding a display region of the LCD panel;
coating a black material on a surrounding area of a first light shielding region forming a second light shielding region, the first light shielding region formed on a light shielding layer of the mask;
illuminating UV light on top of the mask and the LCD panel for solidifying the sealant between a TFT substrate and a color filter (CF) substrate; and
absorbing the UV light by an absorbing property of the second light shielding region for preventing the UV light reflected from the non-display region of the LCD panel to reflect again from the second light shielding region to a display region of the LCD panel.

9. The method for a mask utilized in an LCD panel according to claim 8, wherein a material of the second light shielding region is black resin or black ink.

10. The method for a mask utilized in an LCD panel according to claim 8, wherein the method is used to solidify a sealant in a PSVA LCD panel.

11. The method for a mask utilized in an LCD panel according to claim 10, wherein the method is used to prevent monomers within a liquid crystal layer of the LCD panel from being illuminated by the UV light.
